(19) United States
(12) Patent Application Publication
(10) Pub. No.: US 2013/0050131 A1
(43) Pub. Date: Feb. 28, 2013

(54) HOVER BASED NAVIGATION USER INTERFACE CONTROL

(71) Applicants: Choy Wai Lee, Olathe, KS (US); Scott T. Moore, Olathe, KS (US); Kenneth A. Bolton, Olathe, KS (US)

(72) Inventors: Choy Wai Lee, Olathe, KS (US); Scott T. Moore, Olathe, KS (US); Kenneth A. Bolton, Olathe, KS (US)

(73) Assignee: GARMIN SWITZERLAND GMBH, Schaffhausen (CH)

(21) Appl. No.: 13/215,946

(22) Filed: Aug. 23, 2011

(51) Int. Cl. G06F 3/048; G06F 3/033; G06F 3/044

(52) U.S. Cl. 345/174; 715/841; 345/156

(57) ABSTRACT

Hover based control of a navigation user interface of a mobile electronic device is described. In one or more implementations, an input associated with a menu of an electronic map is detected, and an input type determined. When the input type is a hover input, a menu expand function is executed. The menu expand function causes the menu to expand and reveal a menu having at least one menu item related to the electronic map. When the input type is a touch input, a select function is executed. The select function causes a selection of the at least one menu item of the electronic map of the map navigation application.

### BACKGROUND

Because of their relatively small size and form, mobile electronic devices such as personal navigation devices (PNDs) offer several practical advantages with respect to providing maps and map-related content to a user. For example, because of their small form and consequent portability, mobile electronic devices are capable of providing real-time navigational instructions to users in a convenient fashion, while the users are enroute to a destination.

Interaction with the mobile electronic device can occur through touch inputs. For example, interaction can occur via a touch to hard keys, soft keys, and/or a touch screen. Additionally, mobile electronic devices can be employed during various activities such as driving, flying, walking, running, biking, and so forth. Depending on the activity and the functionality of the user interface of the mobile electronic device, touch inputs may be inconvenient and/or unintuitive for receiving user input under a given scenario.

### SUMMARY

Techniques are described to enable hover based control of a navigation user interface of a mobile electronic device. In one or more implementations, an input associated with a menu of an electronic map is detected, and an input type is determined. When the input type is a hover input, a menu expand function may be executed. The menu of the electronic map may include any device controls, including, but not limited to, zoom, volume, pan, character input, etc. The menu expand function causes the menu to expand and reveal a menu having at least one menu item related to the electronic map. When the input type is a touch input, a select function may be executed. The select function causes a selection of the at least one menu item of the electronic map of the map navigation application.

This Summary is provided solely to introduce subject matter that is fully described in the Detailed Description and Drawings. Accordingly, the Summary should not be considered to describe essential features nor be used to determine scope of the claims.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures can indicate similar or identical items.

FIG. 1 is an illustration of an example environment in which techniques may be implemented in a mobile electronic device to furnish hover based control of a navigation user interface of the device.

FIG. 2 is an example operational flow diagram for hover based input for a navigation user interface.

FIG. 3A is an example operational flow diagram for hover based input for a navigation user interface.

FIG. 3B is an illustration of an example screen shot of the mobile electronic device of FIG. 1 executing an example operation associated with the operational flow of FIG. 3A.

FIG. 3C is an illustration of an example screen shot of the mobile electronic device of FIG. 1 executing an example operation associated with the operational flow of FIG. 3A.

FIG. 3D is an illustration of an example screen shot of the mobile electronic device of FIG. 1 executing an example operation associated with the operational flow of FIG. 3A.

FIG. 3E is an illustration of an example screen shot of the mobile electronic device of FIG. 1 executing an example operation associated with the operational flow of FIG. 3A.

FIG. 3F is an illustration of an example screen shot of the mobile electronic device of FIG. 1 executing an example operation associated with the operational flow of FIG. 3A.

FIG. 4A is an example operational flow diagram for hover based input for a navigation user interface.

FIG. 4B is an illustration of an example screen shot of the mobile electronic device of FIG. 1 executing an example operation associated with the operational flow of FIG. 4A.

FIG. 4C is an illustration of an example screen shot of the mobile electronic device of FIG. 1 executing an example operation associated with the operational flow of FIG. 4A.

FIG. 4D is an illustration of an example screen shot of the mobile electronic device of FIG. 1 executing an example operation associated with the operational flow of FIG. 4A.

FIG. 4E is an illustration of an example screen shot of the mobile electronic device of FIG. 1 executing an example operation associated with the operational flow of FIG. 4A.

FIG. 5A is an example operational flow diagram for hover based input for a navigation user interface.

FIG. 5B is an illustration of an example screen shot of the mobile electronic device of FIG. 1 executing an example operation associated with the operational flow of FIG. 5A.

FIG. 5C is an illustration of an example screen shot of the mobile electronic device of FIG. 1 executing an example operation associated with the operational follow of FIG. 5A.

FIG. 5D is an illustration of an example screen shot of the mobile electronic device of FIG. 1 executing an example operation associated with the operational flow of FIG. 5A.

FIG. 5E is an illustration of an example screen shot of the mobile electronic device of FIG. 1 executing an example operation associated with the operational flow of FIG. 5A.

FIG. 6A is an example operational flow diagram for hover based input for a navigation user interface.

FIG. 6B is an illustration of an example screen shot of the mobile electronic device of FIG. 1 executing an example operation associated with the operational flow of FIG. 6A.

FIG. 6C is an illustration of an example screen shot of the mobile electronic device of FIG. 1 executing an example operation associated with the operational flow of FIG. 6A.

### DETAILED DESCRIPTION

Overview

Mobile electronic devices, such as personal navigation devices (PNDs), can be used during a variety of activities. In some situations, mobile electronic devices can be operated while a user is stationary. For example, a user of a mobile electronic device may access a user interface of the device while stationary to set a destination or waypoint. Conversely, mobile electronic devices can also be operated while a user is in motion (e.g., walking, jogging, or running). In such situations, the user interface of the mobile electronic device can be accessed to track speed, direction, routes, calories, heart rate, and so forth. Moreover, mobile electronic devices can be utilized while a user is operating a vehicle (e.g., automobile, aquatic vessel, or aircraft). In such instances, the mobile electronic device can be mounted to a dashboard of a vehicle. The user interface of the mobile electronic device can be accessed to track location, direction, speed, time, waypoints, points of interest, and the like. Accordingly, mobile electronic devices can be utilized during a variety of scenarios, each providing unique challenges associated with providing and receiving a user input to the user interface of the mobile electronic device.

Even though mobile electronic devices can include a variety of user interface types, mobile electronic devices that furnish navigation functionality typically include a map user interface along with one or more menus for interacting with the map and storing information associated with the map. Given the variety of activities indicated above, interaction between the menus and the map can be challenging. For example, a user who is driving an automobile may wish to interact with the mobile electronic device by transitioning from a map user interface and entering a menu user interface in order to select a point of interest (POI) or execute some other function. To accomplish this task, the user must steady a hand and finger to find a hard/soft key to touch in order to bring up a menu and then engage an item of the menu to select the item. Given the precision required for touch inputs, vibrations or bumps experienced while driving (or during other activities such as walking, running, or riding) can make such interaction with the mobile electronic device difficult.

A menu of the electronic map may include any object that is presented to a user by default or otherwise available to be presented. For example, a menu expand function may be executed providing functionality to control an electronic device. For instance, device controls may include, but are not limited to, zoom, volume, pan, back, etc. In some embodiments, a menu expand function may be executed providing functionality to present helpful information. For instance, a menu may provide information such as estimated arrival time, current speed, average speed, and current geographic location (e.g., geographic coordinates, nearest street and number, nearest points of interest, etc.).

In some embodiments, a menu may not be presented to a user on the display until a hover input is detected over a position on the electronic device that is associated with the menu that can detect a hover input. For example, a zoom menu may not be displayed until a hover input is detected over the area associated with the zoom menu. In some embodiments, the area associated with a menu may be configured by default or it may be identified by a user. In some embodiments, the position capable detecting a hover input on the electronic device may be the entire display.

In some embodiments, menus available for the user to touch may change dynamically based on the position of a hover input. This functionality provides flexibility in presenting select touch input options. Multiple unique menus may be divided over a plurality of hover input positions, where each hover input position is associated with multiple menus that are presented when a hover input is detected at each hover input position. For instance, five hover input positions may each be associated with four menus to provide twenty unique menus.

Accordingly, the present disclosure describes techniques that employ hover input types and/or combinations of hover input types and touch input types to provide a simple and intuitive interaction between a map user interface and one or more menu user interfaces of a mobile electronic device. For example, a menu user interface can be actuated from a map user interface via a hover input type. An item of the menu user interface can then be selected by touching (a touch input type) an item within the menu user interface that was actuated by the hover input type. As such, the input types can help facilitate input expectations as the user navigates the mobile electronic device (e.g., a user may be able to easily remember that a hover input causes a menu to actuate and a touch input causes a selection). Moreover, given the potential activities in which mobile electronic devices are employed, a hover input can have a greater tolerance for vibrations and bumps in several scenarios because a hover input is facilitated by an object being detected near the mobile electronic device (as opposed to a touch input where an object must accurately touch a particular area of the user interface). Accordingly, hover based inputs and/or the combination of hover and touch based inputs provide an interaction environment that is simple and intuitive for a user navigating the user interfaces of a mobile electronic device.

In the following discussion, an example mobile electronic device environment is first described. Exemplary procedures are then described that can be employed with the example environment, as well as with other environments and devices without departing from the spirit and scope thereof. Example display screens of the mobile electronic device are then described that can be employed in the illustrated environment, as well as in other environments without departing from the spirit and scope thereof.

Example Environment

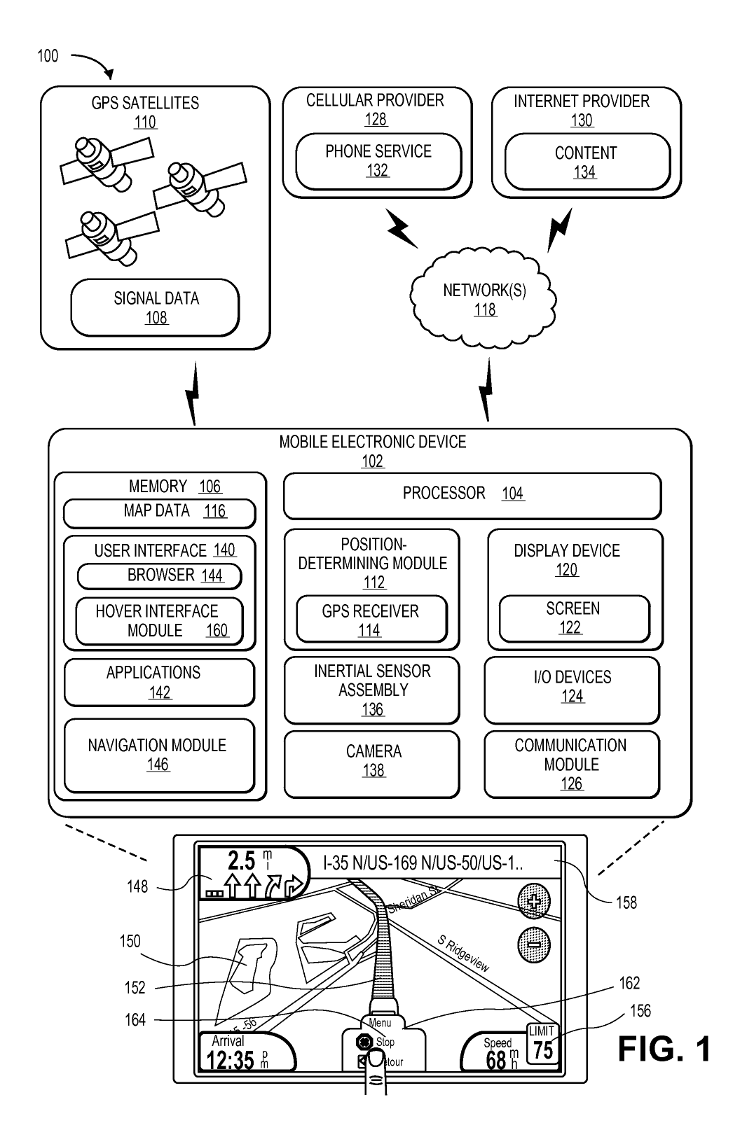

FIG. 1 illustrates an example mobile electronic device environment 100 that is operable to perform the techniques discussed herein. The environment 100 includes a mobile electronic device 102 operable to provide navigation functionality to the user of the device 102. The mobile electronic device 102 can be configured in a variety of ways. For instance, a mobile electronic device 102 can be configured as a portable navigation device (PND), a mobile phone, a smart phone, a position-determining device, a hand-held portable computer, a personal digital assistant, a multimedia device, a game device, combinations thereof, and so forth. In the following description, a referenced component, such as mobile electronic device 102, can refer to one or more entities, and therefore by convention reference can be made to a single entity (e.g., the mobile electronic device 102) or multiple entities (e.g., the mobile electronic devices 102, the plurality of mobile electronic devices 102, and so on) using the same reference number.

In FIG. 1, the mobile electronic device 102 is illustrated as including a processor 104 and a memory 106. The processor 104 provides processing functionality for the mobile electronic device 102 and can include any number of processors, micro-controllers, or other processing systems, and resident or external memory for storing data and other information accessed or generated by the mobile electronic device 102. The processor 104 can execute one or more software programs which implement the techniques and modules described herein. The processor 104 is not limited by the materials from which it is formed or the processing mechanisms employed therein and, as such, can be implemented via semiconductor(s) and/or transistors (e.g., electronic integrated circuits (ICs)), and so forth.

The memory 106 is an example of device-readable storage media that provides storage functionality to store various data associated with the operation of the mobile electronic device 102, such as the software program and code segments mentioned above, or other data to instruct the processor 104 and other elements of the mobile electronic device 102 to perform the techniques described herein. Although a single memory 106 is shown, a wide variety of types and combinations of memory can be employed. The memory 106 can be integral with the processor 104, stand-alone memory, or a combination of both. The memory 106 can include, for example, removable and non-removable memory elements such as RAM, ROM, Flash (e.g., SD Card, mini-SD card, micro-SD Card), magnetic, optical, USB memory devices, and so forth. In embodiments of the mobile electronic device 102, the memory 106 can include removable ICC (Integrated Circuit Card) memory such as provided by SIM (Subscriber Identity Module) cards, USIM (Universal Subscriber Identity Module) cards, UICC (Universal Integrated Circuit Cards), and so on.

The mobile electronic device 102 is further illustrated as including functionality to determine position. For example, mobile electronic device 102 can receive signal data 108 transmitted by one or more position data platforms and/or position data transmitters, examples of which are depicted as the Global Positioning System (GPS) satellites 110. More particularly, mobile electronic device 102 can include a position-determining module 112 that can manage and process signal data 108 received from GPS satellites 110 via a GPS receiver 114. The position-determining module 112 is representative of functionality operable to determine a geographic position through processing of the received signal data 108. The signal data 108 can include various data suitable for use in position determination, such as timing signals, ranging signals, ephemerides, almanacs, and so forth.

Position-determining module 112 can also be configured to provide a variety of other position-determining functionality. Position-determining functionality, for purposes of discussion herein, can relate to a variety of different navigation techniques and other techniques that can be supported by “knowing” one or more positions. For instance, position-determining functionality can be employed to provide position/location information, timing information, speed information, and a variety of other navigation-related data. Accordingly, the position-determining module 112 can be configured in a variety of ways to perform a wide variety of functions. For example, the position-determining module 112 can be configured for outdoor navigation, vehicle navigation, aerial navigation (e.g., for airplanes, helicopters), marine navigation, personal use (e.g., as a part of fitness-related equipment), and so forth. Accordingly, the position-determining module 112 can include a variety of devices to determine position using one or more of the techniques previously described.

The position-determining module 112, for instance, can use signal data 108 received via the GPS receiver 114 in combination with map data 116 that is stored in the memory 106 to generate navigation instructions (e.g., turn-by-turn instructions to an input destination or POI), show a current position on a map, and so on. Position-determining module 112 can include one or more antennas to receive signal data 108 as well as to perform other communications, such as communication via one or more networks 118 described in more detail below. The position-determining module 112 can also provide other position-determining functionality, such as to determine an average speed, calculate an arrival time, and so on.

Although a GPS system is described and illustrated in relation to FIG. 1, it should be apparent that a wide variety of other positioning systems can also be employed, such as other global navigation satellite systems (GNSS), terrestrial based systems (e.g., wireless phone-based systems that broadcast position data from cellular towers), wireless networks that transmit positioning signals, and so on. For example, positioning-determining functionality can be implemented through the use of a server in a server-based architecture, from a ground-based infrastructure, through one or more sensors (e.g., gyros, odometers, and magnetometers), use of “dead reckoning” techniques, and so on.

The mobile electronic device 102 includes a display device 120 to display information to a user of the mobile electronic device 102. In embodiments, the display device 120 can comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display device 120 can be backlit via a backlight such that it can be viewed in the dark or other low-light environments.

The display device 120 can be provided with a screen 122 for entry of data and commands. In one or more implementations, the screen 122 comprises a touch screen. For example, the touch screen can be a resistive touch screen, a surface acoustic wave touch screen, a capacitive touch screen, an infrared touch screen, optical imaging touch screens, dispersive signal touch screens, acoustic pulse recognition touch screens, combinations thereof, and the like. Capacitive touch screens can include surface capacitance touch screens, projected capacitance touch screens, mutual capacitance touch screens, and self-capacitance touch screens. In implementations, the screen 122 is configured with hardware to generate a signal to send to a processor and/or driver upon detection of a touch input and/or a hover input. As indicated herein, touch inputs include inputs, gestures, and movements where a user's finger, stylus, or similar object, contacts the screen 122. Hover inputs include inputs, gestures, and movements where a user's finger, stylus, or similar object, does not contact the screen 122, but is detected proximal to the screen 122.

The mobile electronic device 102 can further include one or more input/output (I/O) devices 124 (e.g., a keypad, buttons, a wireless input device, a thumbwheel input device, a trackstick input device, and so on). The I/O devices 124 can include one or more audio I/O devices, such as a microphone, speakers, and so on.

The mobile electronic device 102 can also include a communication module 126 representative of communication functionality to permit mobile electronic device 102 to send/receive data between different devices (e.g., components/peripherals) and/or over the one or more networks 118. Communication module 126 can be representative of a variety of communication components and functionality including, but not limited to: one or more antennas; a browser; a transmitter and/or receiver; a wireless radio; data ports; software interfaces and drivers; networking interfaces; data processing components; and so forth.

The one or more networks 118 are representative of a variety of different communication pathways and network connections which can be employed, individually or in combinations, to communicate among the components of the environment 100. Thus, the one or more networks 118 can be representative of communication pathways achieved using a single network or multiple networks. Further, the one or more networks 118 are representative of a variety of different types of networks and connections that are contemplated, including, but not limited to: the Internet; an intranet; a satellite network; a cellular network; a mobile data network; wired and/or wireless connections; and so forth.

Examples of wireless networks include, but are not limited to: networks configured for communications according to: one or more standard of the Institute of Electrical and Electronics Engineers (IEEE), such as 802.11 or 802.16 (Wi-Max) standards; Wi-Fi standards promulgated by the Wi-Fi Alliance; Bluetooth standards promulgated by the Bluetooth Special Interest Group; and so on. Wired communications are also contemplated such as through universal serial bus (USB), Ethernet, serial connections, and so forth.

The mobile electronic device 102, through functionality represented by the communication module 126, can be configured to communicate via one or more networks 118 with a cellular provider 128 and an Internet provider 130 to receive mobile phone service 132 and various content 134, respectively. Content 134 can represent a variety of different content, examples of which include, but are not limited to: map data which can include speed limit data; web pages; services; music; photographs; video; email service; instant messaging; device drivers; instruction updates; and so forth.

The mobile electronic device 102 can further include an inertial sensor assembly 136 that represents functionality to determine various manual manipulation of the device 102. Inertial sensor assemblyl36 can be configured in a variety of ways to provide signals to enable detection of different manual manipulation of the mobile electronic device 102, including detecting orientation, motion, speed, impact, and so forth. For example, inertial sensor assembly 136 can be representative of various components used alone or in combination, such as an accelerometer, gyroscope, velocimeter, capacitive or resistive touch sensor, and so on.

The mobile electronic device 102 of FIG. 1 can be provided with an integrated camera 138 that is configured to capture media such as still photographs and/or video by digitally recording images using an electronic image sensor. As more fully indicated below, the camera 138 can be a forward camera to record hover and/or touch inputs. Media captured by the camera 138 can be stored as digital image files in memory 106 and/or sent to a processor for interpretation. For example, a camera can record hand gestures and the recording can be sent to a processor to identify gestures and/or distinguish between touch inputs and hover inputs. In embodiments, the digital image files can be stored using a variety of file formats. For example, digital photographs can be stored using a Joint Photography Experts Group standard (JPEG) file format. Other digital image file formats include Tagged Image File Format (TIFF), raw data formats, and so on. Digital video can be stored using a Motion Picture Experts Group (MPEG) file format, an Audio Video Interleave (AVI) file format, a Digital Video (DV) file format, a Windows Media Video (WMV) format, and so forth. Exchangeable image file format (Exif) data can be included with digital image files to associate metadata about the image media. For example, Exif data can include the date and time the image media was captured, the location where the media was captured, and the like. Digital image media can be displayed by display device 120 and/or transmitted to other devices via a network 118 (e.g., via an email or MMS text message).

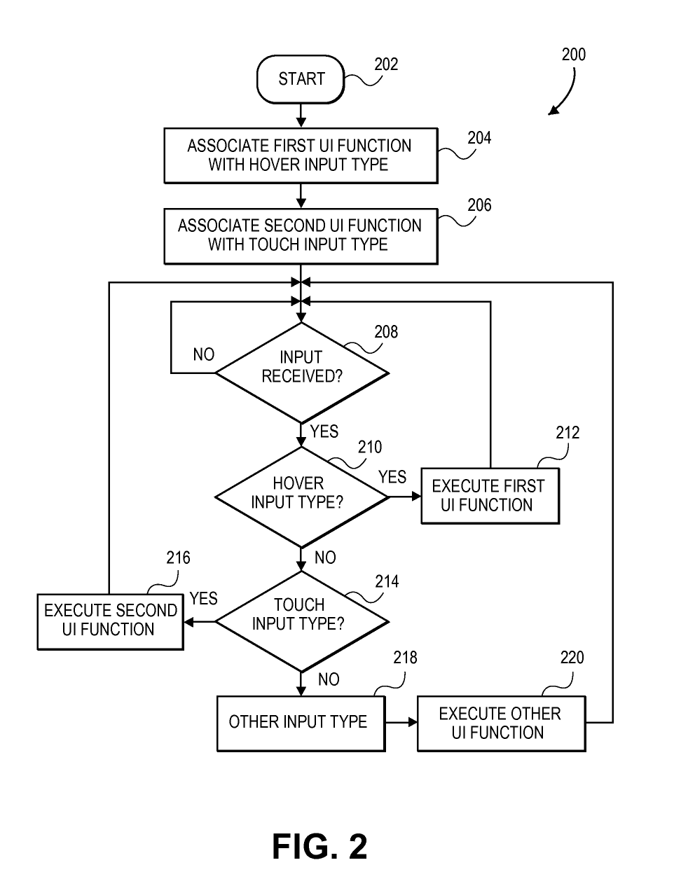

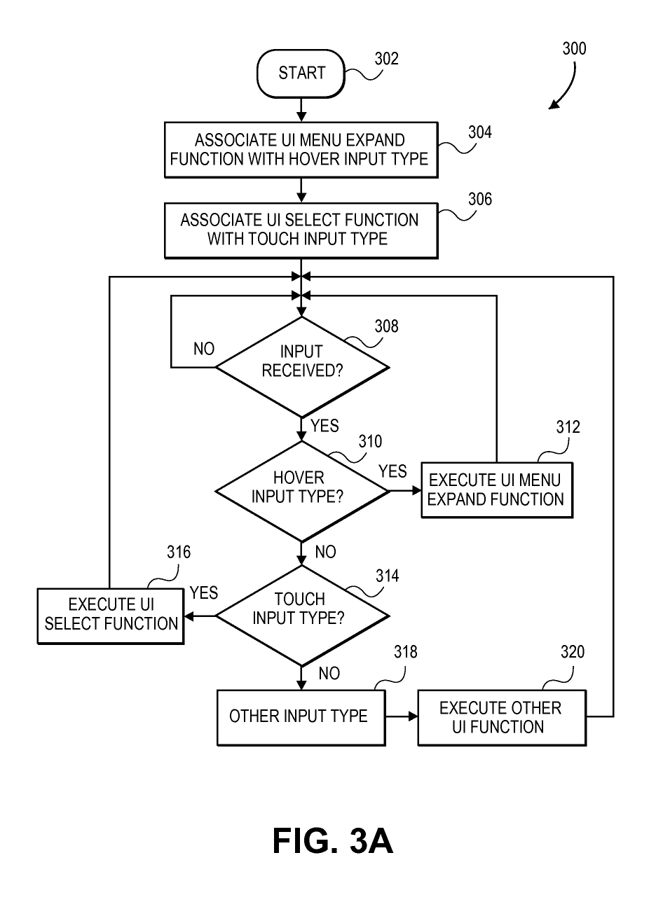

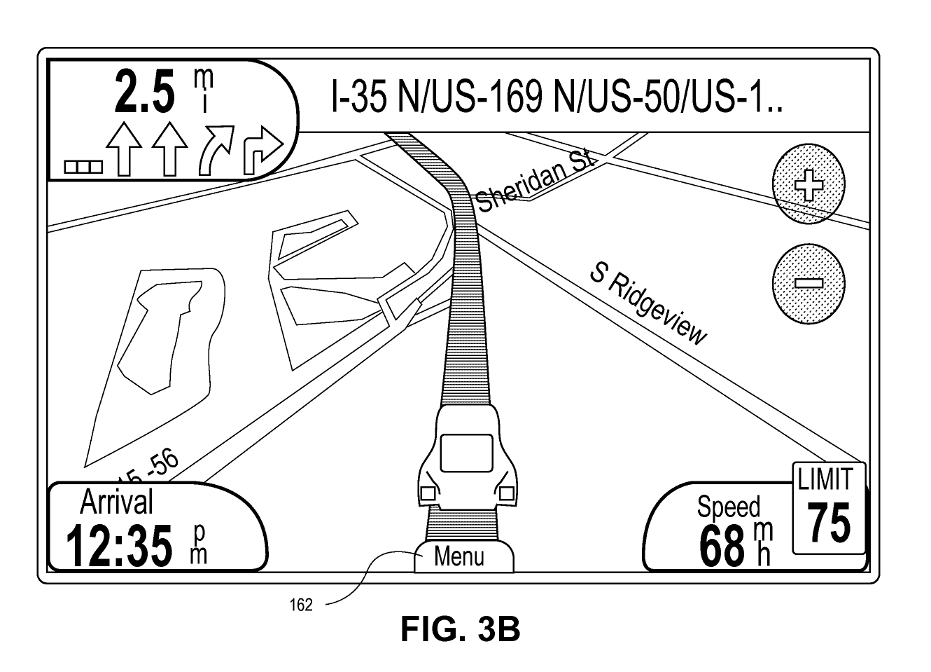

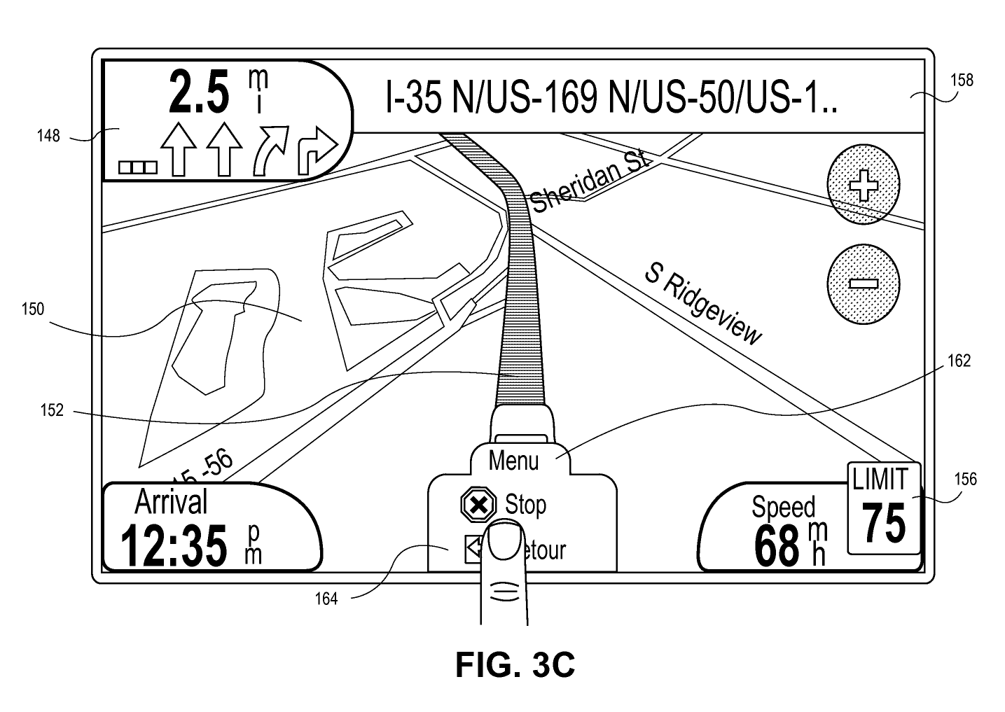

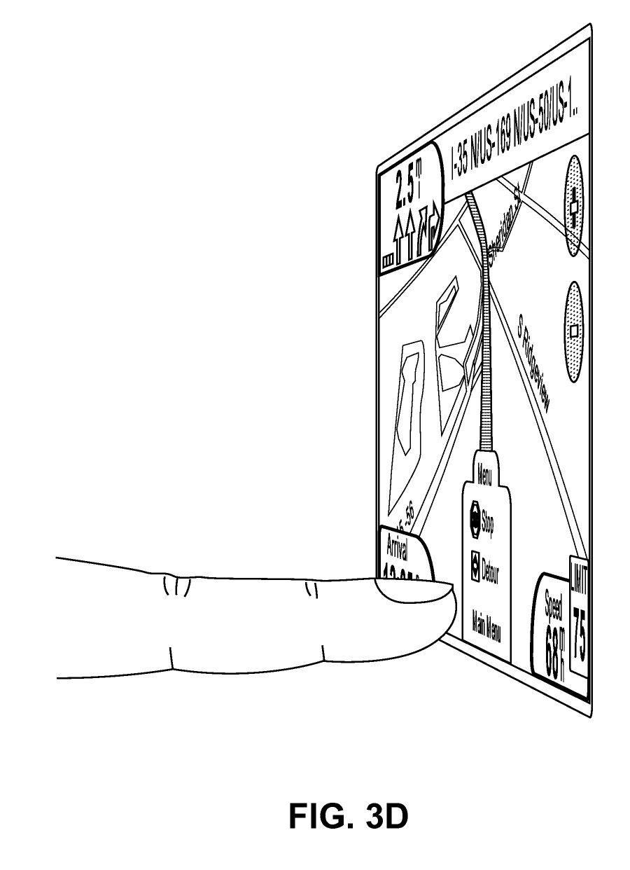

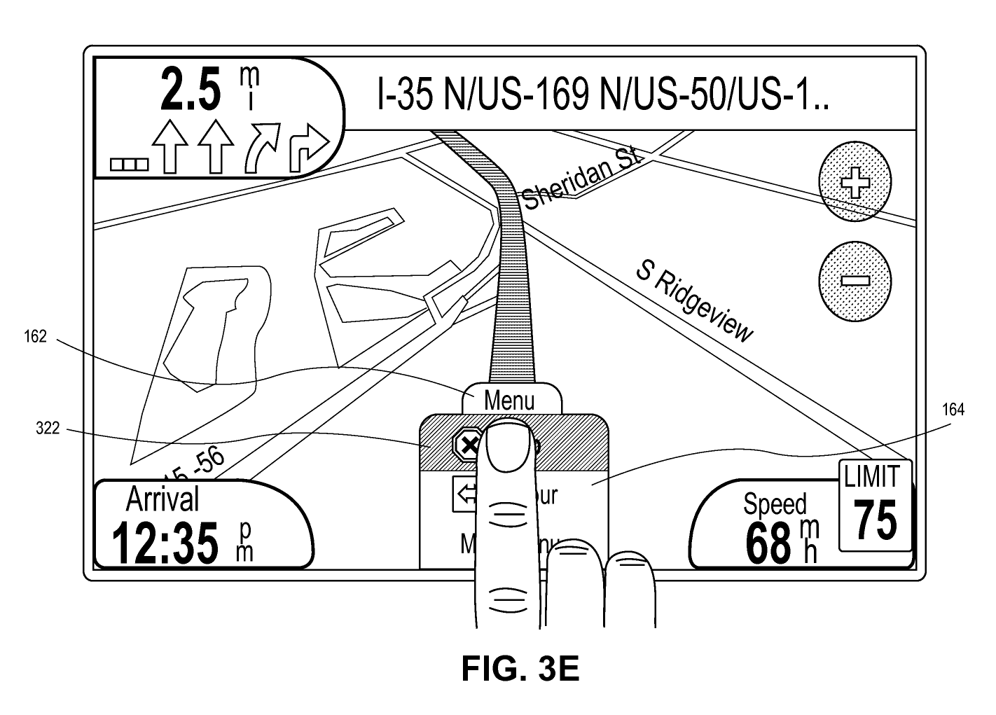

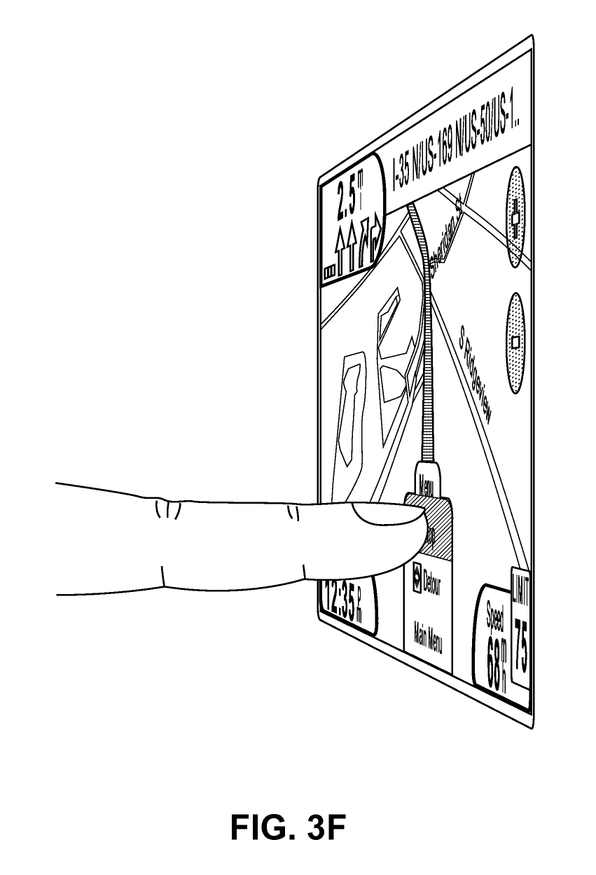

The mobile electronic device 102 is illustrated as including a user interface 140, which is storable in memory 106 and executable by the processor 104. The user interface 140 is representative of functionality to control the display of information and data to the user of the mobile electronic device 102 via the display device 120. In some implementations, the display device 120 may not be integrated into the mobile electronic device 102 and can instead be connected externally using universal serial bus (USB), Ethernet, serial connections, and so forth. The user interface 140 can provide functionality to allow the user to interact with one or more applications 142 of the mobile electronic device 102 by providing inputs via the screen 122 and/or the I/O devices 124. The input types and the functions executed in response to the detection of an input type are more fully set forth below in FIGS. 2 through 6C. For example, as indicated, user interface 140 can include a map user interface, such as map 150 (FIG. 3C), and a menu user interface, such as menu indicator 162 (FIG. 3C). Upon actuation of the menu indicator 162 (FIG. 3B), menu items 164 can be expanded into view.

The user interface 140 can cause an application programming interface (API) to be generated to expose functionality to an application 142 to configure the application for display by the display device 120, or in combination with another display. In embodiments, the API can further expose functionality to configure the application 142 to allow the user to interact with an application by providing inputs via the screen 122 and/or the I/O devices 124.

Applications 142 can comprise software, which is storable in memory 106 and executable by the processor 104, to perform a specific operation or group of operations to furnish functionality to the mobile electronic device 102. Example applications can include cellular telephone applications, instant messaging applications, email applications, photograph sharing applications, calendar applications, address book applications, and so forth.

In implementations, the user interface 140 can include a browser 144. The browser 144 enables the mobile electronic device 102 to display and interact with content 134 such as a web page within the World Wide Web, a webpage provided by a web server in a private network, and so forth. The browser 144 can be configured in a variety of ways. For example, the browser 144 can be configured as an application 142 accessed by the user interface 140. The browser 144 can be a web browser suitable for use by a full-resource device with substantial memory and processor resources (e.g., a smart phone, a personal digital assistant (PDA), etc.). However, in one or more implementations, the browser 144 can be a mobile browser suitable for use by a low-resource device with limited memory and/or processing resources (e.g., a mobile telephone, a portable music device, a transportable entertainment device, etc.). Such mobile browsers typically conserve memory and processor resources, but can offer fewer browser functions than web browsers.

The mobile electronic device 102 is illustrated as including a navigation module 146 which is storable in memory 106 and executable by the processor 104. The navigation module 146 represents functionality to access map data 116 that is stored in the memory 106 to provide mapping and navigation functionality to the user of the mobile electronic device 102. For example, the navigation module 146 can generate navigation information that includes maps and/or map-related content for display by display device 120. As used herein, map-related content includes information associated with maps generated by the navigation module 146 and can include speed limit information, POIs, information associated with POIs, map legends, controls for manipulation of a map (e.g., scroll, pan, etc.), street views, aerial/satellite views, and the like, displayed on or as a supplement to one or more maps.

In one or more implementations, the navigation module 146 is configured to utilize the map data 116 to generate navigation information that includes maps and/or map-related content for display by the mobile electronic device 102 independently of content sources external to the mobile electronic device 102. Thus, for example, the navigation module 146 can be capable of providing mapping and navigation functionality when access to external content 134 is not available through network 118. It is contemplated, however, that the navigation module 146 can also be capable of accessing a variety of content 134 via the network 118 to generate navigation information including maps and/or map-related content for display by the mobile electronic device 102 in one or more implementations.

The navigation module 146 can be configured in a variety of ways. For example, the navigation module 146 can be configured as an application 142 accessed by the user interface 140. The navigation module 146 can utilize position data determined by the position-determining module 112 to show a current position of the user (e.g., the mobile electronic device 102) on a displayed map, furnish navigation instructions (e.g., turn-by-turn instructions to an input destination or POI), calculate driving distances and times, access cargo load regulations, and so on.

As shown in FIGS. 1 and 3C, the navigation module 146 can cause the display device 120 of the mobile electronic device 102 to be configured to display navigation information 148 that includes a map 150, which can be a moving map, that includes a roadway graphic 152 representing a roadway being traversed by a user of the mobile electronic device 102, which may be mounted or carried in a vehicle or other means of transportation. The roadway represented by the roadway graphic 152 can comprise, without limitation, any navigable path, trail, road, street, pike, highway, tollway, freeway, interstate highway, combinations thereof, or the like, that can be traversed by a user of the mobile electronic device 102. It is contemplated that a roadway can include two or more linked but otherwise distinguishable roadways traversed by a user of the mobile electronic device 102. For example, a roadway can include a first highway, a street intersecting the highway, and an off-ramp linking the highway to the street. Other examples are possible.

The mobile electronic device 102 is illustrated as including a hover interface module 160, which is storable in memory 106 and executable by the processor 104. The hover interface module 160 represents functionality to enable hover based control of a navigation user interface of the mobile electronic device 102 as described herein below with respect to FIGS. 2 through 6C. The functionality represented by the hover interface module 160 thus facilitates the use of hover input types and/or combinations of hover input types and touch input types to provide a simple and intuitive interaction between a map user interface and one or more menu user interfaces of the mobile electronic device 102. In the implementation illustrated, the hover interface module 160 is illustrated as being implemented as a functional part of the user interface 140. However, it is contemplated that the hover interface module 160 could also be a stand-alone or plug-in module stored in memory 106 separate from the user interface 140, or could be a functional part of other modules (e.g., the navigation module 145), and so forth.

Generally, any of the functions described herein can be implemented using software, firmware, hardware (e.g., fixed logic circuitry), manual processing, or a combination of these implementations. The terms “module” and “functionality” as used herein generally represent software, firmware, hardware, or a combination thereof. The communication between modules in the mobile electronic device 102 of FIG. 1 can be wired, wireless, or some combination thereof. In the case of a software implementation, for instance, the module represents executable instructions that perform specified tasks when executed on a processor, such as the processor 104 within the mobile electronic device 102 of FIG. 1. The program code can be stored in one or more device-readable storage media, an example of which is the memory 106 associated with the mobile electronic device 102 of FIG. 1.

Example Procedures

The following discussion describes procedures that can be implemented in a mobile electronic device providing navigation functionality. The procedures can be implemented as operational flows in hardware, firmware, or software, or a combination thereof. These operational flows are shown below as a set of blocks that specify operations performed by one or more devices and are not necessarily limited to the orders shown for performing the operations by the respective blocks. In portions of the following discussion, reference can be made to the environment 100 of FIG. 1. The features of the operational flows described below are platform-independent, meaning that the operations can be implemented on a variety of commercial mobile electronic device platforms having a variety of processors.

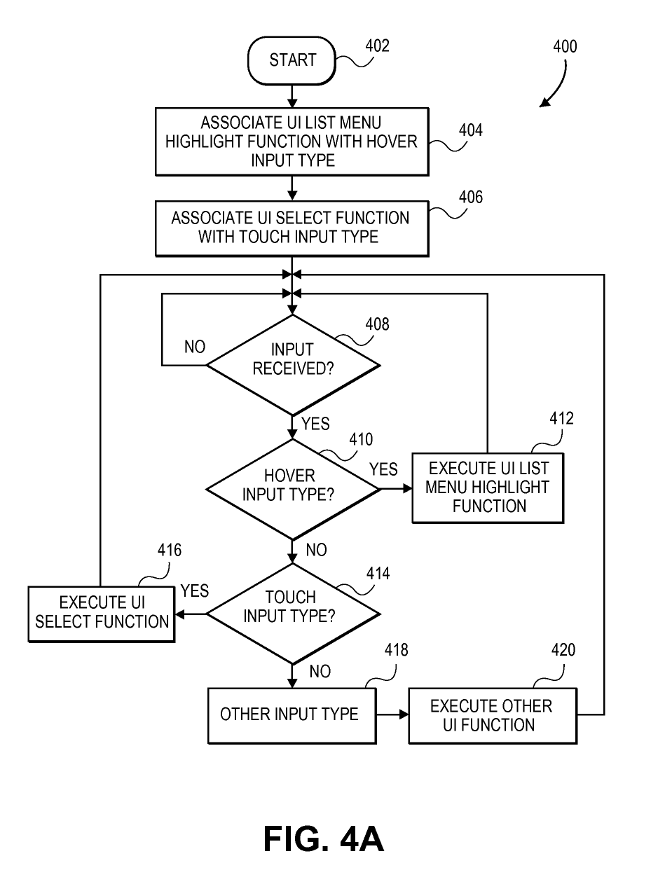

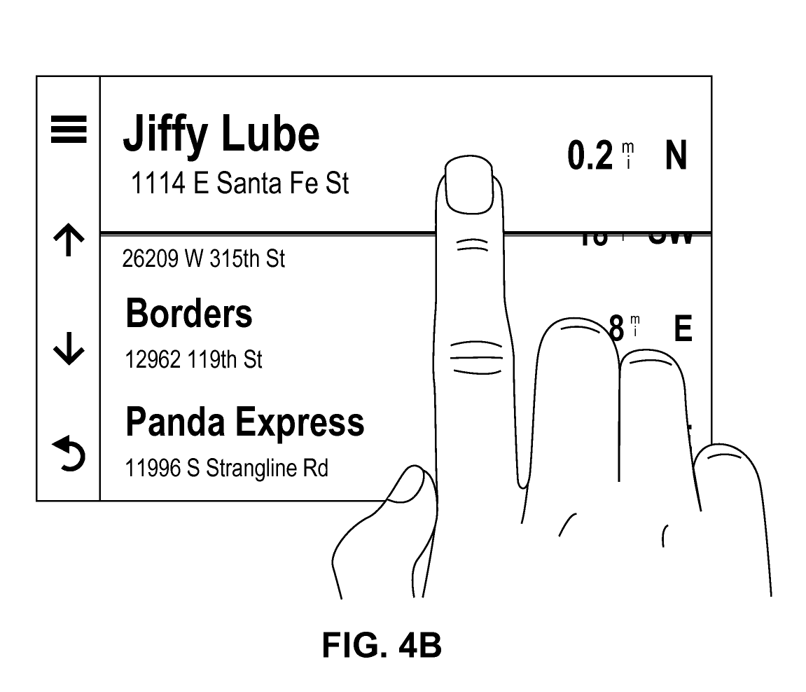

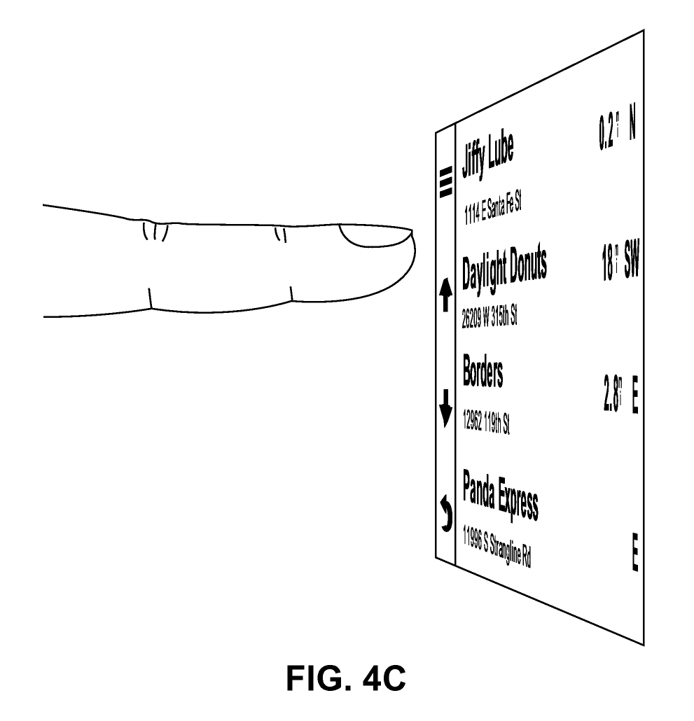

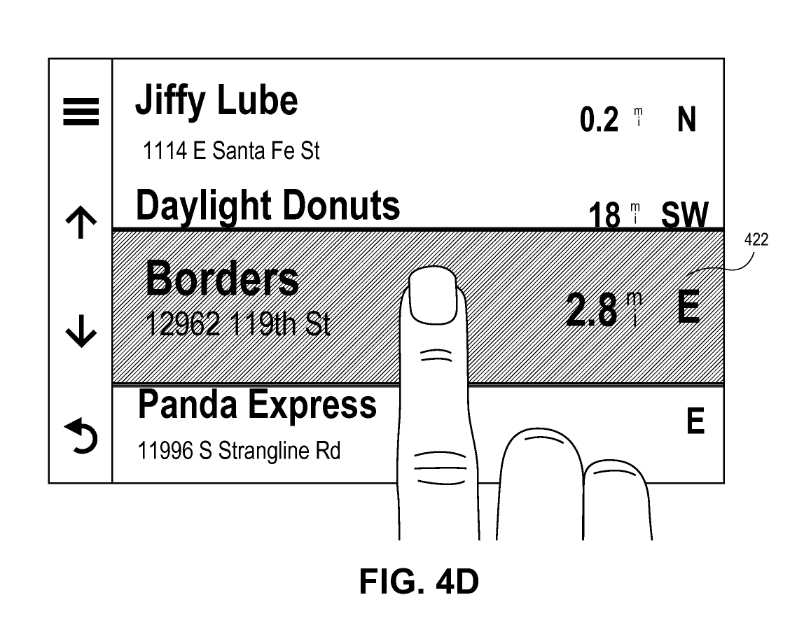

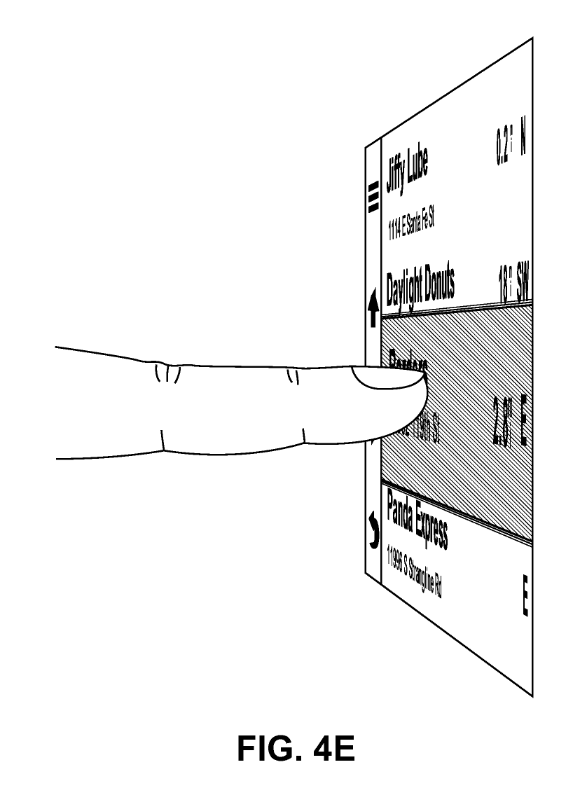

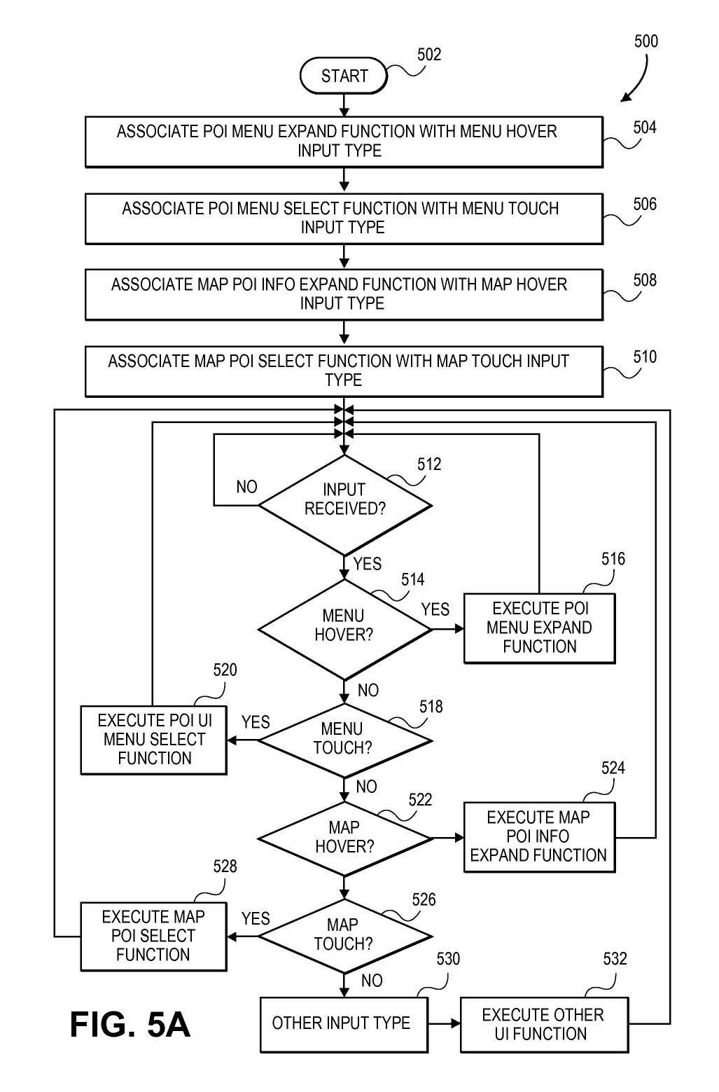

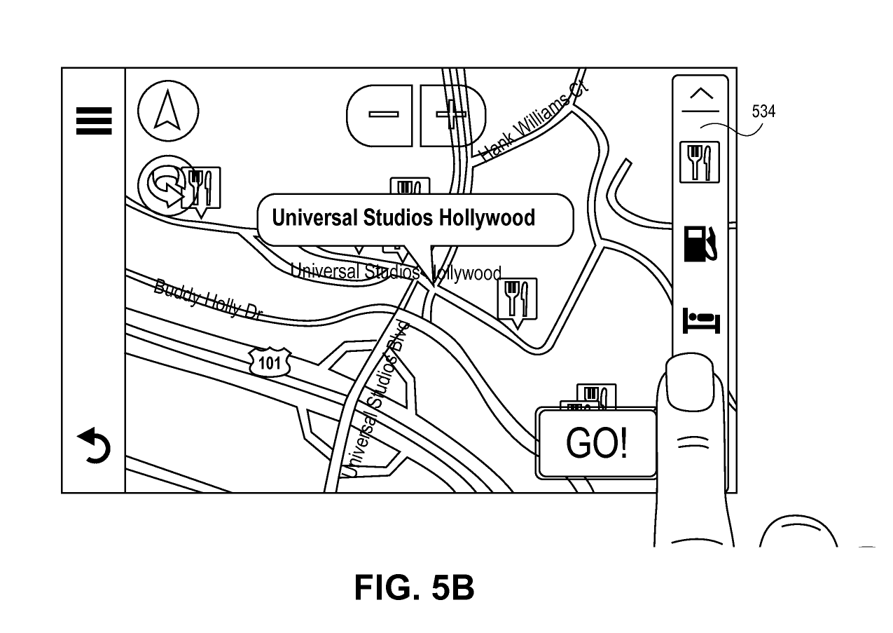

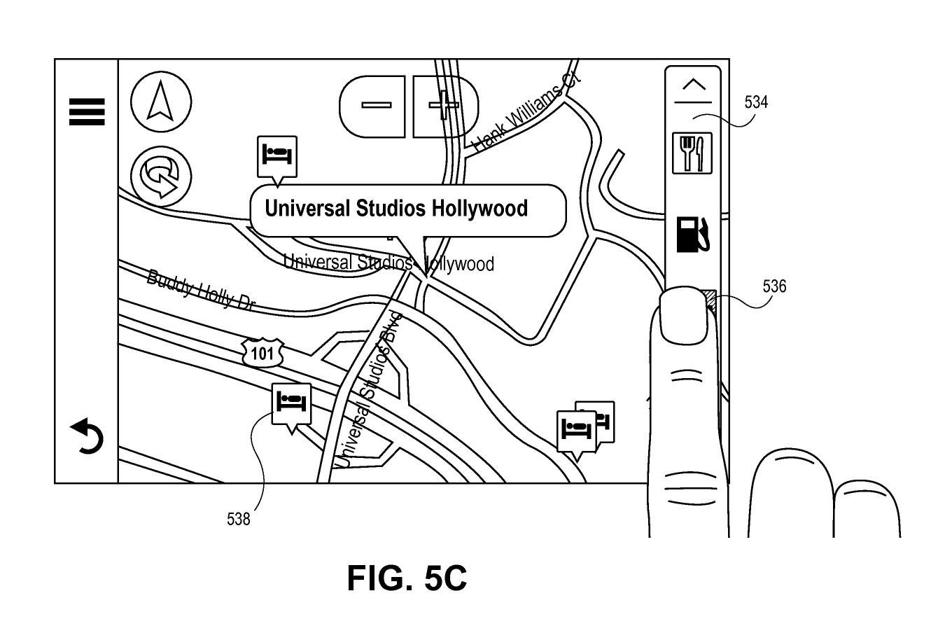

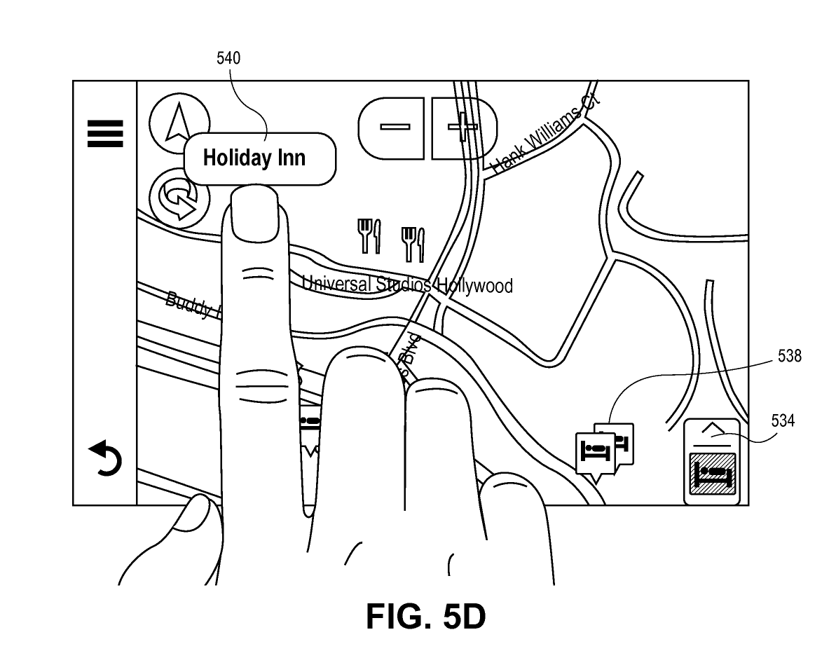

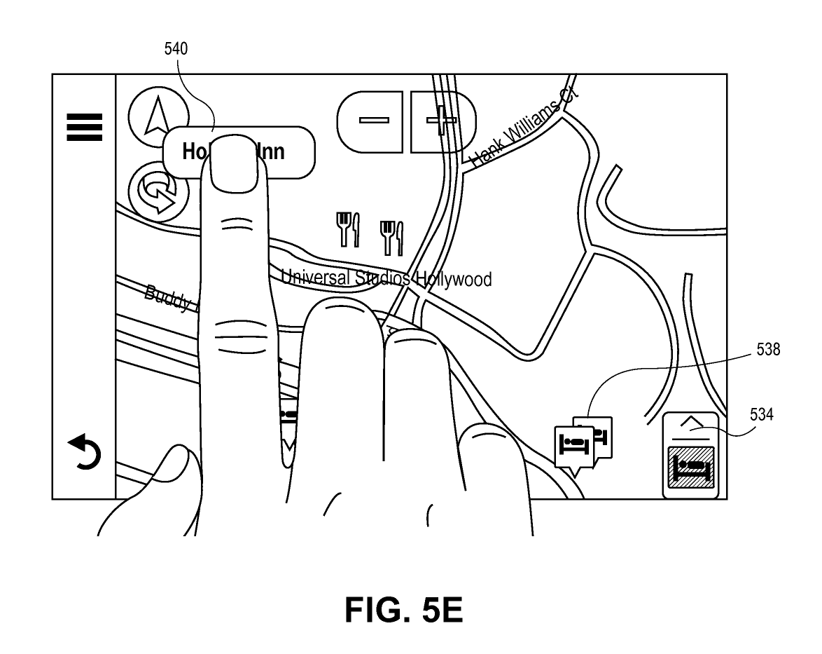

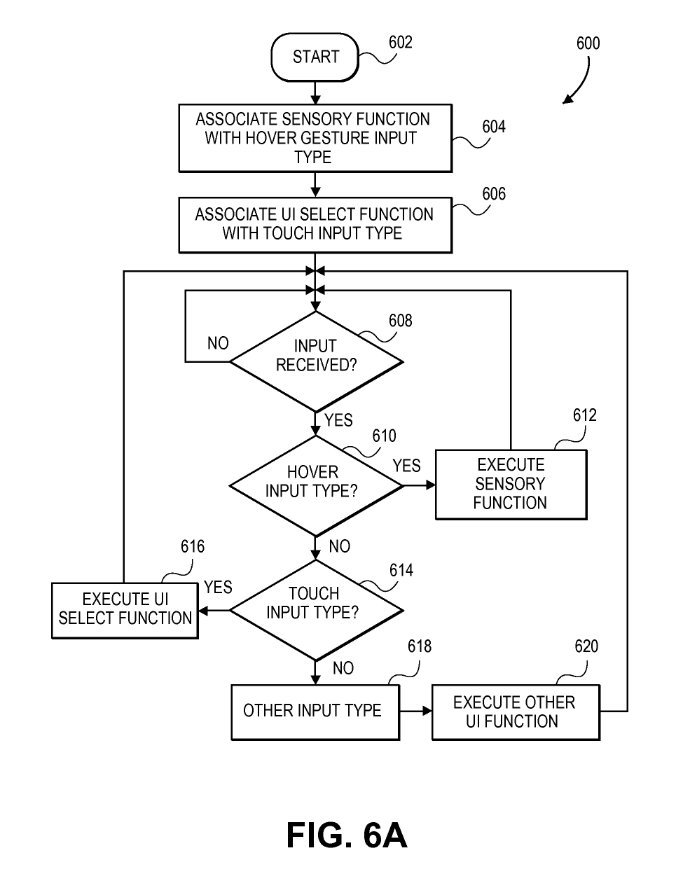

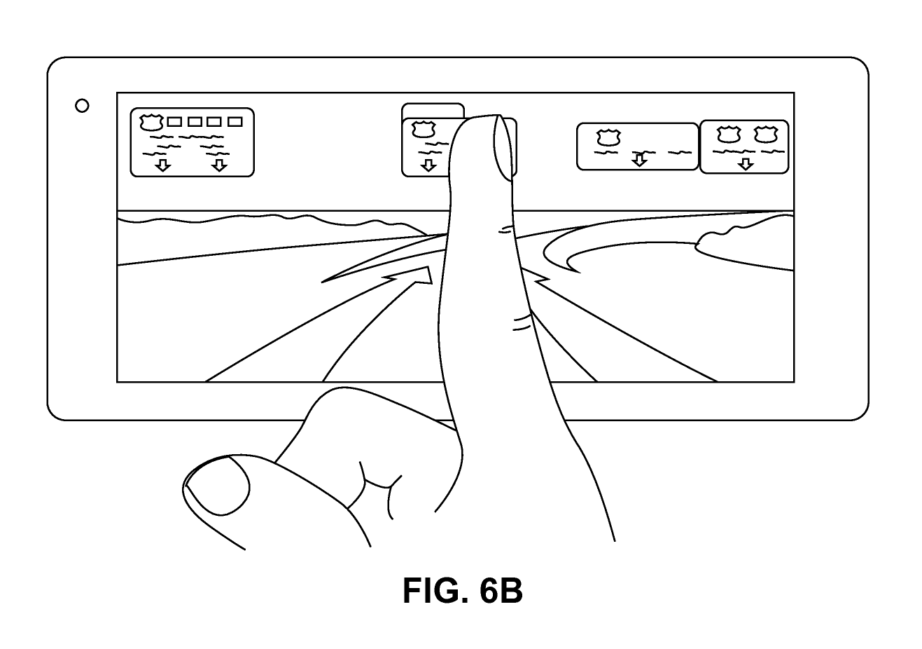

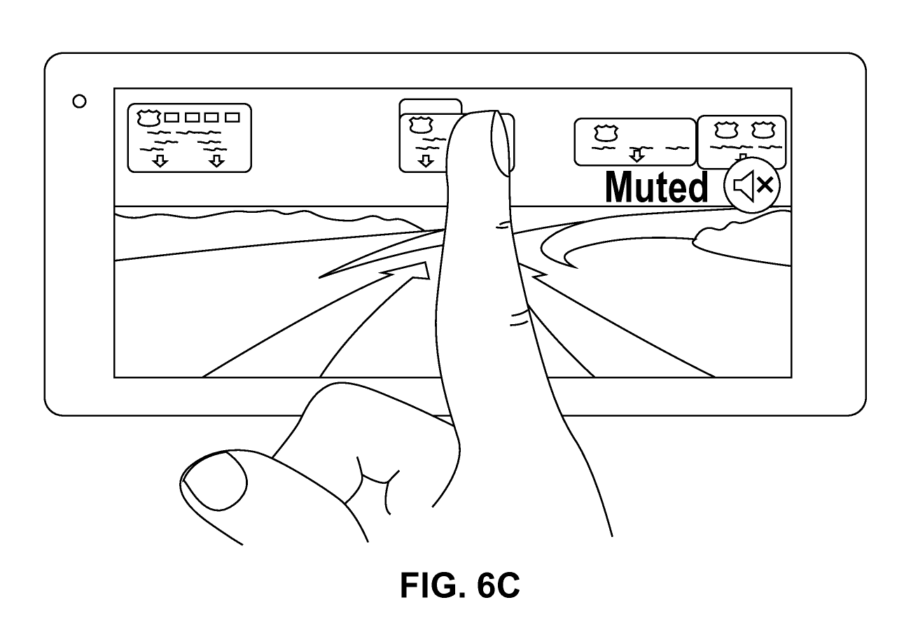

As more fully set forth below, FIG. 2 presents an example operational flow that includes operations associated with hover based navigation user interface control. FIGS. 3A through 3F present an example operational flow and provide example screen shots that illustrate example features of hover based navigation user interface control associated with an expandable menu. FIGS. 4A through 4E present an example operational flow and provide example screen shots that illustrate example features of hover based navigation user interface control associated with a list menu. FIGS. 5A through 5E present an example operational flow and provide example screen shots that illustrate example features of hover based navigation user interface control associated with a point-of-interest map and menu. FIGS. 6A through 6C present an example operational flow and provide example screen shots that illustrate example features of hover based navigation user interface control associated with a gesture actuated sensory function. As more fully set forth herein, FIGS. 3A through 6C include several examples associated with hover based navigation user interface control. However, this disclosure is not limited to such examples. Moreover, the examples are not mutually exclusive. The examples can include combinations of features between the examples.

FIG. 2 illustrates an example operational flow that includes operations associated with hover based navigation user interface control. As will be more fully apparent in light of the disclosure below, operations 210 through 220 are depicted in an example order. However, operations 210 through 220 can occur in a variety of orders other than that specifically disclosed. For example, in one implementation, decision operation 214 can occur before decision operation 210 or after operation 218. In other implementations, operation 218 can occur before decision operation 210 or before decision operation 214. Other combinations are contemplated in light of the disclosure herein, as long as the operations are configured to determine the type of input received.

Operational flow 200 begins at start operation 202 and continues to operation 204. At operation 204, a first user interface function can be associated with a hover input type. As indicated in operation 204, a first user interface function can be any function that causes a change in the user interface. For example, the user interface function can be a visual user interface function. Visual user interface functions can include functions that alter brightness, color, contrast, and so forth. For example, a visual user interface function can alter the brightness of a display to enhance the visual perception of the display between a daytime and nighttime mode. Visual user interface functions can also include functions that cause an actuation of an interface object. For example, the actuation or opening of a menu can be a visual user interface function. Other visual user interface functions can include highlighting and/or magnification of an object. In one or more implementations, visual user interface functions can include the selection of an object or control of the display.

A user interface function can further include audio user interface functions. For example, audio user interface functions can include a volume increase function, a volume decrease function, a mute function, an unmute function, a sound notification change function, a language change function, a change to accommodate the hearing impaired, and/or the like. In implementations, a user interface function can include tactile based user interface functions. For example, a tactile based user interface function can include the control of any vibratory actuation of the device. The above examples are but a few examples of user interface functions. User interface functions can include any functions that cause a change on the device.

Operation 204 further includes a hover type input. Another way to describe a hover type input is a touchless input. A hover input can include any input that is detectable by the mobile electronic device 102 where a user's finger does not physically contact a I/O device 124 or a screen 122. A hover input can include the detection of a fingertip or other object proximal (but not touching) to the mobile electronic device 102. For example, FIGS. 3D and 4C indicate a hover type input. In other implementations, a hover input can include the detection of a gesture associated with a hand or other object proximal to (but not touching) the mobile electronic device 102. For example, FIGS. 6B and 6C indicate another type of hover input. As an example, a gesture can include sign language or other commonly used hand signals. In the examples in FIGS. 6B and 6C, the hover type input is a “hush” hand signal (i.e., only the index finger is extended).

A hover input can be detected by the mobile electronic device 102 instantaneous to the hover action. In other implementations, the detection can be associated with a hover timing threshold. For example, to minimize accidental inputs, the detection of an object associated with the hover can be sustained for a predetermined time threshold. For example, the threshold can be about 0.1 seconds to about 5.0 seconds. In other implementations, the threshold can be about 0.5 seconds to about 1.0 second.

A hover input can be detected by the mobile electronic device 102 in a variety of ways. For example, a hover input can be detected via the screen 122. As indicated above, the screen 122 can include a touch screen configured to generate a signal for distinguishing a touch input and a hover input. For example, the touch screen can be a resistive touch screen, a surface acoustic wave touch screen, a capacitive touch screen, an infrared touch screen, optical imaging touch screens, dispersive signal touch screens, acoustic pulse recognition touch screens, combinations thereof, and the like. Capacitive touch screens can include surface capacitance touch screens, projected capacitance touch screens, mutual capacitance touch screens, and self capacitance touch screens. In one implementation, the screen 122 is configured with hardware to generate a signal to send to a processor and/or driver upon detection of a touch input and/or a hover input.

As another example associated with detecting a hover input on the mobile electronic device 102, the mobile electronic device 102 and or the screen 122 can be configured to detect gestures through shadow detection and/or light variances. Light detection sensors can be incorporated below the screen 122, in the screen 122, and/or associated with the housing of the mobile electronic device 102. The detected light variances can be sent to a processor (e.g., the processor 104) for interpretation. In other implementations, detection of a hover input can be facilitated by the camera 138. For example, the camera 138 can record video associated with inputs proximal to the camera 138. The video can be sent to a processor (e.g., processor 104) for interpretation to detect and/or distinguish input types.

In some embodiments, the mobile electronic device 102 can determine the direction of a hover input and identify a user based on the directional information. For example, a mobile electronic device 102 positioned on a vehicle dashboard can identify whether the hover input is being inputted by the vehicle operator or vehicle passenger based on the direction of the hover input. If the mobile electronic device 102 is configured for a vehicle in which the vehicle operator sits on the left side of the mobile electronic device 102 and uses his right hand to access the center of the vehicle dashboard, a hover input of a left to right direction of the screen 122 may be associated with the vehicle operator and a hover input of a right to left direction of the screen 122 may be associated with the vehicle passenger. If the mobile electronic device 102 is configured for a vehicle in which the vehicle operator sits on the right side of the mobile electronic device 102 and uses his left hand to access the center of the vehicle dashboard, a hover input of a right to left direction of the screen 122 may be associated with the vehicle operator and a hover input of a left to right direction of the screen 122 may be associated with the vehicle passenger. The mobile electronic device 102 may also be configured for use unrelated to vehicle operation wherein the mobile electronic device 102 may determine the direction of a hover input and identify a user based on the directional information.

In some embodiments, the mobile electronic device 102 may determine a user's gesture from the direction of a hover input and associate functionality with the hover input. The mobile electronic device 120 may determine a user gesture of horizontal, vertical, or diagonal hover input movement across the display device 102 and associate functionality with the gestures. For example, the mobile electronic device 102 may associate a horizontal gesture of a hover input from a left to right direction of screen 122, or a vertical gesture of a hover input from a bottom to top direction of screen 122, with transitioning from a first functionality to a second functionality. In some embodiments, the functionality associated with various gestures may be programmable.

The mobile electronic device 102 may associate multiple hover inputs without a touch input with functionality. For example, mobile electronic device 102 may associate a user applying and removing a hover input multiple times to screen 122 with a zoom or magnification functionality for the information presented on display device 120.

Operation 204 indicates that a first user interface function can be associated with a hover input type. The association of the first user interface function with the hover input type can be preset by a device manufacturer. The association of the first user interface function with the hover input type can also be configured by a third party software manufacturer that configures a software product for the device. The association of the first user interface function with the hover input type can also be configured by a user as a user preference. For example, a user can select one or more user interface functions to execute upon receiving a hover input type.

In some embodiments, the mobile electronic device 102 may present an indication of functionality associated with a touch input while receiving a hover input. For example, if the touch input is associated with map functionality, an icon associated with the functionality may be presented on the display device 120 while the mobile electronic device 102 receives a hover input. In some embodiments, a semi-transparent layer of functionality associated with the touch input may be presented on the display device 120 while the mobile electronic device 102 receives a hover input. If the touch input is associated with a map, the mobile electronic device 102 may present a semi-transparent map on the display device 120. The map may be static or updated in real-time.

From operation 204, operational flow 200 can continue to operation 206. At operation 206 a second user interface function can be associated with a touch input type. The second user interface function indicated in operation 206 can include any of the user interface functions discussed in association with operation 204. Moreover, as opposed to a hover input type, a touch input type is an input where a user's finger physically contacts an I/O device 124 or a screen 122 to cause the input. For example, FIGS. 3F and 4E depict touch input types. A touch input can be detected and/or distinguished from a hover input type with similar hardware and software functionality as indicated above in association with operation 204. Also, similar to the association of a hover input, the association of a touch input can be preset by a device manufacturer, configured by a third party software manufacturer, and/or associated via a user preference.

In some embodiments, the mobile electronic device 102 may anticipate a touch input type that may be selected and initiate a process before receiving a touch input. For example, if there are two touch inputs on the right side of display device 120, the mobile electronic device 102 may initiate one or more processes associated with the touch inputs before a touch input has been received by an I/O device 124 or a screen 122.

From operation 206, operational flow 200 continues to decision operation 208. At decision operation 208, it is decided whether an input has been received. The input can be received via detection of an input. For example, in the situation where the screen 122 is a resistive touch screen, an input can be received when a physical force is detected on the resistive touch screen, the resistive touch screen generates a signal that indicates the physical force, and a driver and/or program related to the resistive touch screen interprets the signal as an input. As another example, in the situation where the screen 122 is a capacitive touch screen, an input can be received when a change in dielectric properties is detected in association with the capacitive touch screen, the capacitive touch screen generates a signal that indicates the change in dielectric properties, and a driver and/or program related to the capacitive touch screen interprets the signal as an input. As still another example, in the situation where mobile electronic device 102 is associated with light detecting diodes, an input can be received when a change in light properties is detected (e.g., a shadow) in association with the screen 122, the diodes cause a signal that indicates the detected light properties, and a driver and/or program related to the diodes interprets the signal as an input. In yet another example, in the situation where the mobile electronic device 102 is associated with a camera 138, an input can be received when an image is received, the image is sent to a processor or program for interpretation and the interpretation indicates an input. The above examples are but a few examples of determining whether an input has been received.

When it is determined that an input has not been received, operational flow 200 loops back up and waits for an input. In the situation where an input has been received, operational flow 200 continues to decision operation 210. At decision operation 210, it is determined whether a hover input type has been received. As stated above, operational flow 200 can also determine whether the input type is a touch input and/or other input type at decision operation 210. Again, the order of determining input types is not important. A hover input type can be detected in a plurality of ways. For example, in the situation where the screen 122 is a capacitive touch screen, a hover input type can be detected with a driver and/or software associated with the capacitive touch screen that interprets a change in dielectric properties associated with an input. For example, such a change may indicate that an input object is spaced from the capacitive touch screen (e.g., see FIGS. 3D and 4C). As another example, in the situation where the mobile electronic device 102 is associated with light detecting diodes, a hover input type can be detected when a driver and/or program associated with the light detecting diodes interprets a light property (e.g., a shadow) associated with an input as indicating that that an input object is spaced from the screen 122. As still another example, in the situation where the mobile electronic device 102 is associated with a camera 138, a hover input type can be detected when a driver and/or program associated with the camera 138 interprets an image associated with the input as indicating that an input object is spaced from the screen 122.

When it is determined that the received input is a hover input type, operational flow 200 continues to operation 212 where the first user interface function is executed. For example, a processor can cause the execution of code to realize the first user interface function. From operation 212, operational flow 200 can loop back to decision operation 208 as indicated.

When it is determined that the received input is not a hover input type, operational flow 200 can continue to decision operation 214. Again, as stated above, the order of determining input types can be interchanged. At decision operation 214, it is determined whether the received input is a touch input type. A touch input type can be detected in a plurality of ways. For example, in the situation where the screen 122 is a capacitive touch screen, a touch input type can be detected with a driver and/or software associated with the capacitive touch screen that interprets a change in dielectric properties associated with an input. For example, such a change may indicate that an input object is in contact with the capacitive touch screen (e.g., FIGS. 3F and 4E). As another example, in the situation where the mobile electronic device 102 is associated with light detecting diodes, a touch input type can be detected when a driver and/or program associated with the light detecting diodes interprets a light property (e.g., a shadow) associated with an input as indicating that an input object is in contact with the screen 122. As still another example, in the situation where the mobile electronic device 102 is associated with camera 138, a touch input type can be detected when a driver and/or program associated with a camera 138 interprets an image associated with the input as indicating that an input object is in contact with screen 122.

When it is determined that the received input is a touch input type, operational flow 200 continues to operation 216 where the second user interface function is executed. For example, a processor can cause the execution of code to realize the second user interface function. From operation 216, operational flow 200 can loop back to decision operation 208 as indicated.

When it is determined that the received input is not a touch input type, operational flow 200 can continue to operation 218 where it is determined that the input type is another type of input. Other inputs can include audio inputs, voice inputs, tactile inputs, accelerometer based inputs, and the like. From operation 218, operational flow 200 can continue to operation 220 where a function is executed in accordance to the other input. Operational flow 200 can then loop back to decision operation 208.

FIGS. 3A through 3F present an example operational flow and provide example screen shots that illustrate example features of hover based navigation user interface control associated with an expandable menu. The hardware and software functionality described above in association with FIG. 2 are equally applicable in FIG. 3 and will not be repeated herein. As will be more fully apparent in light of the disclosure below, operations 310 through 320 are depicted in an order. However, operations 310 through 320 can occur in a variety of orders. Other combinations are apparent in light of the disclosure herein as long as the operations are configured to determine a type of input received.

Operational flow 300 begins at start operation 302 and continues to operation 304. At operation 304, a menu expand function can be associated with a hover input type. For example, FIGS. 3B through 3D include example screen shots indicating a menu expand function that is associated with a hover input type. FIG. 3B includes an example screen shot where a menu indicator 162 is populated on the edge of the display device 120. Even though the menu indicator 162 is indicated as a menu tab, the menu indicator 162 can include any type of indicator for expanding and hiding menu items 164. Moreover, even though the menu indicator 162 is indicated on a lower edge of the display device 120, the menu indicator 162 can be populated in any location on the display device 120.

From operation 304, operational flow 300 can continue to operation 306. At operation 306 a user interface select function can be associated with a touch type input. For example, FIGS. 3E and 3F include example screen shots indicating a user interface select function that is associated with a touch input type. FIGS. 3E and 3F include example screen shots where the menu indicator 162 has been expanded via a hover input to reveal menu items 164 and a selected menu item 322 is indicated upon a touch input.

From operation 306, operational flow 300 continues to decision operation 308 where it is determined whether an input is received. Determining whether an input is received is more fully set forth above in association with FIG. 2. When an input is not received, operational flow 300 loops back as indicated. When an input is received, operational flow 300 continues to decision operation 310.

At decision operation 310, it is determined whether the received input is a hover input type. Such a determination is more fully set forth above in association with FIG. 2. When the received input is a hover input type, operational flow 300 can continue to operation 312 where the user interface expand function is executed. As indicated in FIGS. 3C and 3D, a user hovers a finger over the menu indicator 162. While hovering, the menu indicator 162 expands to reveal the menu items 164. In one implementation, the expansion can remain even after the hover input is no longer detected. In other implementations, the menu indicator 162 collapses after the hover input is no longer detected. In still other implementations, the menu indicator 162 collapses after the expiration of a time period from the detected hover input. For instance, the functionality associated with a hover input continues after the hover input is no longer detected for a period of time or until the occurrence of an event (e.g., detection of a touch input). For instance, the functionality associated with a hover input may continue for thirty seconds after the hover input was last detected. In some embodiments, the continuation of functionality associated with a hover input may be configurable by a user.

In one implementation, operational flow 300 continues from operation 312 back to decision operation 308 where it is determined that another input has been received. In this example, operational flow 300 continues to decision operation 314 where it is determined that a touch type input has been received. In such a situation, operational flow 300 continues to operation 316 where a user interface select function is executed. Continuing with the above example, a user is hovering a finger over the menu indicator 162 as depicted in FIGS. 3C and 3D. While hovering, the menu indicator 162 expands to reveal the menu items 164. While the menu indicator 162 is expanded, the user touches a menu item (e.g., a control) 322 to cause the menu item 322 as indicated in FIGS. 3E through 3F to be selected. Accordingly, as indicated in this example, a first detected input type is a hover input that causes the menu indicator 162 to expand and reveal the menu items 164. A second detected input type is a touch input that is received while the menu indicator 162 is expanded and causes selection of a single menu item 164. In some implementations, a touch input may cause the selection of two or more menu items 164. In one implementation, the menu item 164 is a control for controlling one or more features of the map 150.

Operational flow 300 can continue from operation 316 to decision operation 308. Moreover, operational flow 300 can include operations 318 and 320 which are more fully described above in association with FIG. 2.

FIGS. 4A through 4E present an example operational flow and provide example screen shots that illustrate example features of hover based navigation user interface control associated with a list menu. The hardware and software functionality described above in association with FIG. 2 are equally applicable in FIG. 4 and are not repeated herein. As will be more fully apparent in light of the disclosure below, operations 410 through 420 are depicted in an order. However, operations 410 through 420 can occur in a variety of orders. Other combinations are apparent in light of the disclosure herein as long as the operations are configured to determine a type of input received.

Operational flow 400 begins at start operation 402 and continues to operation 404. At operation 404, a user interface list menu highlight function can be associated with a hover input type. A highlight function can include, but is not limited to, a color highlight, a magnify highlight, a boldface highlight, a text change highlight, and/or any other type of highlight that provides an indicator to distinguish a potentially selected item of a list. For example, FIGS. 4B and 4C include example screen shots indicating a user interface list menu highlight function that is associated with a hover input type. FIG. 4B includes an example screen shot where a menu item is highlighted (e.g., magnified) in response to a detected hover input proximal to the menu item.

From operation 404, operational flow 400 can continue to operation 406. At operation 406, a user interface select function can be associated with a touch type input. For example, FIGS. 4D through 4E include example screen shots indicating a user interface select function that is associated with a touch input type. FIGS. 4D and 4E include example screen shots where a menu item 422 has been highlighted via a hover input and a selected menu item 422 is indicated upon a touch input. In one implementation, the selected menu item 422 is a control that is actuated to control a feature of the map upon selection.

From operation 406, operational flow 400 continues to decision operations 408 where it is determined whether an input is received. Determining whether an input is received is more fully set forth above in association with FIG. 2. When an input is not received, operational flow 400 continues as indicated. When an input is received, operational flow 400 continues to decision operation 410.

At decision operation 410, it is determined whether the received input is a hover input type. Such a determination is more fully set forth above in association with FIG. 2. When the received input is a hover input type, operational flow 400 can continue to operation 412 where the user interface list highlight function is executed. As indicated in FIGS. 4B and 4C, a user hovers a finger over a menu item 422 and the menu item 422 is highlighted. In one implementation, the highlight can remain even after the hover input is no longer detected. In other implementations, the highlight can cease after the hover input is no longer detected. In still other implementations, the highlight can cease after the expiration of a time period from the detected hover input.

In one implementation, operational flow 400 continues from operation 412 back to decision operation 408 where it is determined that another input has been received. In this example, operational flow 400 continues to decision operation 414 where it is determined that a touch type input has been received. In such a situation, operational flow 400 continues to operation 416 where a user interface select function is executed. Continuing with the above example, a user is hovering a finger over a menu item as depicted in FIGS. 4B and 4C. While hovering, the menu item is highlighted. As indicated in FIGS. 4D and 4E,while menu item 422 is highlighted, the user may physically touch a menu item 422 to select the menu item 422. Any functionality associated with menu item 422 may be executed after menu item 422 is selected.

Operational flow 400 can continue from operation 416 and loop back up to decision operation 408. Moreover, operational flow 400 can include operations 418 and 420 which are more fully described above in association with FIG. 2.

FIGS. 5A through 5E present an example operational flow and provide example screen shots that illustrate example features of hover based navigation user interface control associated with a point-of-interest map and menu. Similar to the above, the hardware and software functionality described above in association with FIG. 2 are equally applicable in FIG. 5 and are not repeated herein. As will be more fully apparent in light of the disclosure below, operations 514 through 532 are depicted in an order. However, similar to the other operational flows indicated herein, operations 514 through 532 can occur in a variety of orders as long as the operations are configured to determine a type of input received.

Operational flow 500 begins at start operation 502 and continues to operation 504. At operation 504, a point-of interest (“POI”) menu expand function can be associated with a hover input type. For example, FIG. 5B includes an example screen shot illustrating a POI menu 534 expanded by the POI menu expand function that is associated with a hover input type.

From operation 504, operational flow 500 can continue to operation 506. At operation 506, a POI menu select function can be associated with a touch type input. For example, FIG. 5C includes an example screen shot illustrating a POI item 536 being selected via a touch input to cause execution of the POI menu select function. The execution of the POI menu select function can cause a highlight of the POI menu item 536 and/or population of the map with POI map items 538 that correspond to a category of the POI menu item 536 at a location in the map that corresponds to a physical geographical location.

From operation 506, operational flow 500 can continue to operation 508. At operation 508, a map POI information expand function can be associated with a hover input type. For example, FIG. 5D includes an example screen shot indicating POI expanded information 540 expanded by the POI information expand function that is associated with a hover input type. In the example in FIG. 5D, the expanded information includes the name of a hotel that is related to the POI map item 538 having a hover input type detected.

From operation 508, operational flow 500 can continue to operation 510. At operation 510, a map POI select function can be associated with a map touch input type. As an example in FIG. 5E, expanded information 540 is selected via the touch input type.

From operation 510, operational flow 500 continues to decision operation 512 where it is determined whether an input is received. Determining whether an input is received is more fully set forth above in association with FIG. 2. When an input is not received, operational flow 500 loops back as indicated. When an input is received, operational flow 500 continues to decision operation 514.

At decision operation 514, it is determined whether the received input is a hover input type associated with a POI menu. Such a determination is more fully set forth above in association with FIG. 2. When the received input is a hover input type associated with a POI menu, operational flow 500 can continue to operation 516 where the POI menu expand function is executed. In one implementation, the expansion can remain even after the hover input is no longer detected. In other implementations, the menu indicator collapses after the hover input is no longer detected. In still other implementations, the menu indicator collapses after the expiration of a time period from the detected hover input.

In one implementation, operational flow 500 continues from operation 516 back to decision operation 512 where it is determined that another input has been received. In this example, operational flow 500 continues to decision operation 518 where it is determined that a touch type input has been received. In such a situation, operational flow 500 continues to operation 520 where a POI menu select function is executed. Continuing with the above example, a user is hovering a finger over POI menu 534 as depicted in FIG. 3B. While hovering, POI menu 534 expands to reveal POI menu items 536. While POI menu 534 is expanded, the user touches a POI menu item. The selection can cause a highlight of the POI menu item 536 and the population of the map with POI map items 538.

From operation 520, operational flow 500 can loop back to decision operation 512 where it is determined that another input has been received. Continuing with the above example, operational flow 500 can continue to decision operation 522 where it is determined that a map hover input has been received. In such a situation, operational flow 500 continues to operation 524 where a map POI information expand function is executed. As indicated in FIG. 5D, the detected hover input causes map POI information to expand to reveal the name of the hotel associated with the POI that was selected during operation 520.

From operation 524, operational flow 500 continues to decision operation 512 where it is determined that another input has been received. Further continuing with the above example, operational flow 500 can continue to decision operation 526 where it is determined that a map touch input has been received. In such a situation, operational flow 500 continues to operation 526 where a map POI select function is executed. As indicated in FIG. 5D, the detected touch input causes a selection of the name of the hotel expanded during operation 524 and that is associated with the POI that was selected during operation 520.

Operational flow 500 can continue from operation 528 to decision operation 512. Moreover, operational flow 500 can include operations 530 and 532 which are more fully described above in association with FIG. 2.

FIGS. 6A through 6C present an example operational flow and provide example screen shots that illustrate example features of hover based navigation user interface control associated with a gesture actuated sensory function. Similar to the above, the hardware and software functionality described above in association with FIG. 2 are equally applicable in FIG. 6 and are not repeated herein. As will be more fully apparent in light of the disclosure below, operations 610 through 620 are depicted in an order. However, similar to the other operational flows indicated herein, operations 610 through 620 can occur in a variety of orders as long as the operations are configured to determine a type of input received.

Operational flow 600 begins at start operation 602 and continues to operation 604. At operation 604, a sensory function can be associated with a hover gesture input type. As more fully indicated above, sensory functions can include a mute function, an unmute function, an increase volume function, a decrease volume function, an increase brightness function, a decrease brightness function, an increase contrast function, a decrease contrast function, and/or any other function change that can cause a change on the mobile electronic device that affects a user's sensory perception. A hover gesture input can include any of a plurality of hand, finger, or object signals. As an example in FIGS. 6B and 6C, a “hush” signal is hovered near the mobile electronic device to cause a mute function. Other signals can also be utilized such as thumbs-up signals, thumbs-down signals, and the like.

From operation 604, operational flow 600 can continue to operation 606. At operation 606, a user interface select function can be associated with a touch type input. For example, a touch type input can cause execution of an unmute function.

From operation 606, operational flow 600 continues to decision operation 608 where it is determined whether an input is received. Determining whether an input is received is more fully set forth above in association with FIG. 2. When an input is not received, operational flow 600 loops back as indicated. When an input is received, operational flow 600 continues to decision operation 610.

At decision operation 610, it is determined whether the received input is a hover gesture input type. Such a determination is more fully set forth above in association with FIG. 2. When the received input is a hover gesture input type, operational flow 600 can continue to operation 612 where the sensory function is executed. Continuing with the examples in FIGS. 6B through 6C, the “hush” gesture causes a mute function.

In one implementation, operational flow 600 continues from operation 612 back to decision operation 608 where it is determined that another input has been received. In this example, operational flow 600 continues to decision operation 614 where it is determined that a touch type input has been received. In such a situation, operational flow 600 continues to operation 616 where a user interface select function is executed. Continuing with the above example, the touch type input can cause an unmute of the mobile electronic device.

Operational flow 600 can continue from operation 616 and loop back up to decision operation 608. Moreover, operational flow 600 can include operations 618 and 620 which are more fully described above in association with FIG. 2.

In some embodiments, when the input type is a hover input, a menu expand function may be executed providing functionality for a user to input one or more characters (alphabet characters, numbers, symbols, etc). For instance, an electronic device may identify a character input (e.g., keyboard key) associated with the current position of a hover input to present an indication of an input the user would select if the user proceeds with a touch input at the current position of the electronic device. In some embodiments, the inputs presented may change dynamically based on a hover input to improve the accuracy of inputs by a user of an electronic device. For instance, a character input may be highlighted and/or magnified if a hover input is detected over a position on the electronic device that is associated with the character input.

In some embodiments, when the input type is a hover input, a menu expand function may be executed providing functionality to control an electronic device. For instance, device controls may include, but are not limited to, zoom, volume, pan, back, etc. The device control information may only be presented after a hover input is detected. In some embodiments, a menu expand function may be executed providing functionality to present helpful information. For instance, a menu may provide information such as estimated arrival time, current speed, average speed, and current geographic location (e.g., geographic coordinates, nearest street and number, nearest points of interest, etc).

In some embodiments, when the input type is a hover input, a menu expand function may be executed providing functionality associated with a point of interest (POI). For instance, a hover input detected over a position of the electronic device that is associated with one or more POIs may present a menu containing menu items associated with a POI (e.g., route from current position to POI, go to POI, information about POI, etc). A touch input detected over a position of the electronic device that is associated with the menu item will execute the functionality associated with that menu item.

In some embodiments, when the input type is a hover input, a menu expand function may be executed providing information associated with information presented on an electronic map. For instance, information associated with a geographic position of the presented map information may be presented to a user if a hover input is detected over a position on the electronic device that corresponds to the electronic map (e.g., elevation at the detected position, depth of a body of water at the detected position, etc). In some embodiments, information associated with a geographic position of a map may be presented if a hover input is detected over a position that corresponds to the electronic map (e.g., roadway traffic, speed limit, etc).

In some embodiments, when the input type is a hover input, the transparency of elements presented on an electronic device may change dynamically based on the hover input. For instance, the transparency of a map layer presented on a display device may be variably increase (i.e., become more transparent) as the hover input is determined to be closer to an input area (e.g., screen) of the electronic device.

In some embodiments, when the input type is a hover input, a different layer of an electronic map may be presented to a user for geographic locations if a hover input is detected over a position on the electronic device that corresponds to the electronic map. For instance, a first map layer may be presented to a user until a hover input is detected over a position on the electronic device, after which a second map layer may be presented. In some embodiments, a map layer may represent cartographic data and/or photographic images (e.g., satellite imagery, underwater environment, roadway intersections, etc).

In some embodiments, a hover input may only be detected under certain conditions. For instance, detection of hover inputs may be deactivated if it is determined that the electronic device is being held in a user's hands (i.e., not mounted to a windshield, dashboard, or other structure). In some embodiments, detection of hover inputs may be activated if it is determined that the electronic device is attached to a device mount. For instance, detection of hover inputs may be activated if the electronic device is attached to a vehicle windshield, vehicle dashboard, or other structure. In some embodiments, the conditions defining the activation and deactivation of hover input functionality may be configurable by a user.

Conclusion

Although techniques to furnish hover based control of a navigation user interface of a mobile electronic device have been described in language specific to structural features and/or methodological acts, it is to be understood that the appended claims are not necessarily limited to the specific features or acts described. Rather, the specific features and acts are disclosed as exemplary forms of implementing the claimed devices and techniques.

What is claimed is:

1. A mobile electronic device, comprising:
a display device having a screen;
a memory operable to store one or more modules; and
a processor operable to execute the one or more modules to:
detect an input associated with a menu of an electronic map of a map navigation application,
determine an input type for the detected input, and
when the input type is a hover input, cause the processor to execute a menu expand function, the menu expand function causing the menu to expand to reveal a menu having at least one menu item related to the electronic map of the map navigation application.

2. The mobile electronic device as recited in claim 1, wherein the processor is operable to execute one or more modules to, when the input type is a touch input, cause the processor to execute a select function, the select function causing a selection of the at least one menu item of the electronic map of the map navigation application.

3. The mobile electronic device as recited in claim 1, wherein the processor is operable to, while the menu is expanded, detect an input type of touch input associated with at least one menu item of the electronic map of the map navigation application, and cause the processor to execute a select function, wherein the select function causes the processor to execute code associated with at least one menu item for the electronic map.

4. The mobile electronic device as recited in claim 1, wherein the screen comprises a capacitive touch screen.

5. The mobile electronic device as recited in claim 4, wherein the capacitive touch screen comprises at least one of a surface capacitance touch screen, a projected capacitance touch screen, a mutual capacitance touch screen and a self-capacitance touch screen.

6. The mobile electronic device as recited in claim 4, wherein determining an input type for the detected input comprises receiving a signal sent by the capacitive touch screen that indicates a change in dielectric properties of the capacitive touch screen, the input type determined based on the change.

7. The mobile electronic device as recited in claim 1, further comprising at least one light detecting sensor.

8. The mobile electronic device as recited in claim 7, wherein determining an input type for the detected input includes causing the at least one light detecting sensor to detect a light differential associated with the screen, wherein the input type is determined based on the light differential.

9. The mobile electronic device as recited in claim 1, further comprising at least one camera.

10. The mobile electronic device as recited in claim 9, wherein determining the input type for the detected input includes causing the at least one camera to capture an image external to the screen, wherein the input type determined based on the captured image.

11. The mobile electronic device as recited in claim 1, wherein causing the menu to expand includes expanding the menu upwardly from an edge portion of the screen.

12. The mobile electronic device as recited in claim 1, wherein the hover input includes a hover duration, and wherein the expansion is maintained during the hover duration.

13. A handheld personal navigation device, comprising:
a display device having a capacitive touch screen;
a memory operable to store one or more modules; and
a processor operable to execute the one or more modules to:
receive a signal from the capacitive touch screen that indicates a change in dielectric properties at a location on the capacitive touch screen associated with a menu displayed with an electronic map of a map navigation application,
based on a change in the dielectric properties of the capacitive touch screen, determine an input type, and
when the change in the dielectric properties of the capacitive touch screen indicates a hover input, cause the processor to execute a menu expand function, the menu expand function causing the menu to expand and reveal a menu having at least one menu item for controlling a feature of the electronic map of the map navigation application.

14. The handheld personal navigation device as recited in claim 13, wherein the processor is operable to execute one or more modules to, when the change in the dielectric properties of the capacitive touch screen indicates a touch input, cause the processor to execute a select function, the select function causing the processor to execute one or more modules related to the at least one menu item to control the feature of the electronic map of the map navigation application.

15. The handheld personal navigation device as recited in claim 13, wherein the processor is operable to, while the menu is expanded, detect an input type of touch input associated with at least one menu item of the electronic map of the map navigation application, and cause the processor to execute a select function, wherein the select function causes the processor to execute code associated with at least one menu item for the electronic map.

16. The handheld personal navigation device as recited in claim 13, wherein the capacitive touch screen comprises at least one of a surface capacitance touch screen, a projected capacitance touch screen, a mutual capacitance touch screen and a self-capacitance touch screen.

17. The handheld personal navigation device as recited in claim 13, wherein causing the menu to expand includes expanding the menu upwardly from an edge portion of the capacitive screen.

18. The handheld personal navigation device as recited in claim 13, wherein the hover input includes a hover duration, and wherein the expansion is maintained during the hover duration.

19. A method comprising:
detecting a hover input associated with a menu indicator displayed with an electronic map of a map navigation application;
upon detecting the hover input, causing a processor to execute a menu expand function, wherein the menu expand function causes the menu indicator to expand and reveal a menu having at least one menu item for the electronic map;
while revealing the menu, detecting a touch input associated with the at least one map control for the electronic map; and
upon detecting the touch input associated with the at least one map control, causing the processor to execute a select function, wherein the select function causes the processor to execute code associated with the at least one map control for the electronic map.

20. The method as recited in claim 19, wherein detecting the hover input includes receiving a signal that indicates a change in dielectric properties and detecting the hover input based on a change in the dielectric properties.

21. The method as recited in claim 19, wherein detecting the hover input includes receiving a captured image associated with a screen and detecting the hover input based on the captured image.

22. The method as recited in claim 19, wherein detecting the hover input includes receiving a signal that indicates a light differential associated with a screen and detecting the hover input based on the light differential.

23. The method as recited in claim 19, wherein causing the menu indicator to expand includes expanding the menu indicator upwardly.

24. The method as recited in claim 19, wherein the hover input includes a hover duration, wherein the expansion is maintained during the hover duration.
